(19) United States
(12) Patent Application Publication
(10) Pub. No.: US 2009/0094064 A1
(43) Pub. Date: Apr. 9, 2009

(54) Healthcare Insurance Claim Fraud and Error Detection Using Co-Occurrence

(76) Inventors: Michael Tyler, San Diego, CA (US); Moiz Saifee, Ujjain (IN); Shafi Rahman, Bangalore (IN); Anu Pathria, San Diego, CA (US); Andrea Allmon, San Diego, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 11/869,628

(22) Filed: Oct. 9, 2007

(51) Int. Cl. G06Q 40/00

(52) U.S. Cl. 705/4

(57) ABSTRACT

A healthcare insurance claim that includes variables characterizing aspects of a healthcare service for which reimbursement is sought is analyzed in order to determine whether there are any aspects that are indicative of fraud or error. This analysis includes generating score variables from the variables of the healthcare insurance claim and determining whether a presence of one or more of the pairs of variables is indicative of fraud or error based on levels of co-occurrence of the one or more pairs in historical healthcare insurance claims. If a positive determination occurs, then the healthcare insurance claim can be flagged or elevated for review by a user. Related techniques, apparatus, systems, and articles are also described.

### TECHNICAL FIELD

The subject matter described herein relates to techniques for detecting fraud or error in healthcare insurance claims using pairwise co-occurrence, either within or across healthcare insurance claim lines.

### BACKGROUND

Healthcare fraud continues to be a growing problem in the United States and abroad. According to the Centers for Medicare and Medicaid Services (CMS), fraud schemes range from those perpetrated by individuals acting alone to broad-based activities by institutions or groups of individuals, sometimes employing sophisticated telemarketing and other promotional techniques to lure consumers into serving as the unwitting tools in the schemes. Seldom do perpetrators target only one insurer or either the public or private sector exclusively. Rather, most are found to be simultaneously defrauding public sector victims such as Medicare and private sector victims simultaneously.

CMS also reports that annual healthcare expenditures in the United States totaled nearly $2 trillion dollars in 2005, and are expected to increase 6.5% a year thereafter. Though the amount lost to healthcare fraud and abuse cannot be precisely quantified, the general consensus is that a significant percentage is paid to fraudulent or abusive claims. Many private insurers estimate the proportion of healthcare dollars lost to fraud to be in the range of 3-5%, which amounts to roughly $30-$50 billion annually. It is widely accepted that losses due to fraud and abuse are an enormous drain on both the public and private healthcare systems.

In Medicare, the most common forms of provider fraud include billing for services not furnished; misrepresenting the diagnosis to justify payment; soliciting, offering, or receiving a kickback; unbundling or “exploding” charges; falsifying certificates of medical necessity, plans of treatment, and medical records to justify payment; billing for a service not furnished as billed. In addition to provider fraud, there is also client abuse, arising from such activities as card-sharing, acting in collusion with a provider for kickbacks, etc.

In order to address these issues, some institutions have adopted rudimentary pre-payment techniques. One such technique is to conduct a manual or automated cross check of the benefits before payment. Namely, administrative staff manually cross-reference the requested benefits payment against eligibility and other records to verify that the payment should be made. Another technique is to employ large sets of rules to describe which services are approved, and which should not occur on a given patient. These large rules databases are unwieldy, are difficult to maintain, and are not comprehensive.

### SUMMARY

The current subject matters allows for an assessment of the likelihood of fraud or error on healthcare insurance claims prior to payment using a measure that looks at the inconsistency of outcomes on one or more healthcare claims. Inconsistencies can be determined on individual claims as well as across claims at higher level entities, such as patients. Outcomes can be represented by individual codes, or by a group of codes in cases where the coding scheme employs a hierarchy. Other features of the claim not directly involved with the inconsistency metric, such as the paid amount, may also be relevant in the scoring of the claim.

In one aspect, data characterizing a healthcare insurance claim is received. The healthcare insurance claim includes variables characterizing aspects of a healthcare service for which reimbursement is sought. The claim is analyzed in order to determine whether there are any aspects that are indicative of fraud or error. This analysis includes generating pairs of variables from the variables of the healthcare insurance claim and determining whether a presence of one or more of the pairs of variables is indicative of fraud or error based on levels of co-occurrence of the one or more pairs in historical healthcare insurance claims. If a positive determination occurs, then the healthcare insurance claim can be flagged or elevated for review by a user or subject to further analysis.

In some implementations, the pairs of variables used in the comparison can be disjoint. Additionally or in the alternative, the notification can identify which variable pairs are indicative of fraud or error. A score can be included in the notification which is based on a level of unusualness for historical pairs of variables. In one variation, the level of unusualness can be determined by dividing a probability of both variables within a pair being present in the historical data by a square root of a product of a probability of a first variable within the pair being present in the historical data and a probability of a second variable within the pair being present in the historical data.

In order to identify appropriate historical data for the generated pairs, the healthcare insurance claim can be associated with an entity level which can be used to reduce the amount of historical data used for co-occurrence determinations.

In an interrelated aspect, data characterizing a healthcare insurance claim that comprises variables which in turn characterize aspects of a healthcare service for which reimbursement is sought is received. Thereafter, first a variable such as a score is generated from the variables of the healthcare insurance claim at a first entity level. It is then determined whether a presence of one or more of the first score variables is indicative of fraud or error based on levels of co-occurrence of the one or more first pairs of variables in historical healthcare insurance claims. If such a determination is positive, then a second score variable can be generated from the variables of the healthcare insurance claim and the first score variable at a second entity level. It is then determined whether a presence of one or more of the second entity level score variables is indicative of fraud or error based on levels of co-occurrence of unusual pairs of variables for one or more lower level entities in historical healthcare insurance claims, indicating abuse at a second entity level. If this latter determination is positive, then notification that the second entity level is indicative of fraud can be initiated. Such notification can include further analysis on the claim or it can include alerting a user (e.g., an adjuster, etc.).

Articles are also described that comprise a machine-readable medium embodying instructions that when performed by one or more machines result in operations described herein. Similarly, computer systems are also described that may include a processor and a memory coupled to the processor. The memory may encode one or more programs that cause the processor to perform one or more of the operations described herein.

The subject matter described herein provides many advantages. For example, using the current techniques fraudulent claims can be identified before they are paid. Claims can be scored using limited information that can be readily accessed, and quickly processed. The technique is adaptive, changing as the historical data and practice patterns change, providing a substantial advantage over a set of rules. Because payors process a large volume of claims, the current techniques are advantageous in that they allow claim adjusters to make quick decisions about the status of a potentially fraudulent claim. Such an arrangement can help minimize the number of possible fraudulent or erroneous claims for an adjuster to review (i.e., false positives suggestive of fraud are reduced).

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a process flow diagram illustrating storing and logically associating e-mails and attachments; and

FIG. 2 is a diagram illustrating entities having varying granularities.

### DETAILED DESCRIPTION

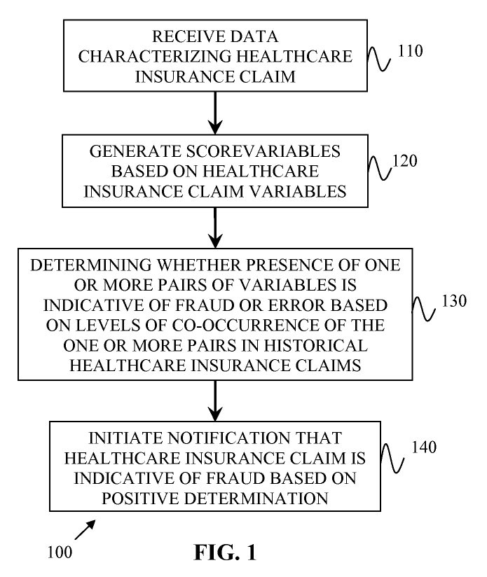

FIG. 1 is a process flow diagram illustrating a method 100, in which, at 110, data characterizing a healthcare insurance claim is received. This claim comprises variables that characterize aspects of a healthcare service for which reimbursement is sought. Thereafter, at 120, one or more score variables are generated from pairs of variables on the healthcare insurance claim. It is then determined, at 130, whether a presence of one or more of the pairs of variables is indicative of fraud or error based on levels of co-occurrence of the one or more pairs in historical healthcare insurance claims. If this determination is positive, then, at 140, notification of same can be initiated (to allow, for example, a user to manually review the healthcare insurance claims, etc.).

The subject matter described herein provides methods and systems for scoring healthcare insurance claims prior to payment, and presenting them to adjusters for review. A healthcare claim can contain many items, including information such as the procedure being performed, the diagnosis code, where the service was performed, and the type of service performed. All of these elements are categorical; these elements have no inherent ordering, and no inherent value attached to them. Some of these elements have hierarchies as well. Procedure codes, for example, can be grouped into categories with similar procedure codes. There can be one or more levels to these hierarchies. All of these items are referred to herein as variables.

Inconsistent healthcare insurance claims can be identified by analyzing an inconsistency score based on one or more of these categorical variables. Consistency (or inconsistency) can be based on co-occurrence (or lack thereof). Statistical analysis of historical healthcare insurance claims data can be used to reveal how common it is for a set of services (as represented by variables) to co-occur on a given client.

Two techniques for assessing consistency of variables are provided herein. These techniques use patterns derived from historical data to determine unusualness. Unusualness can be determined entirely from the data, and requires no clinical knowledge or human intervention (in contrast to a rules-based approach for determining consistency).

In a first variation, healthcare claims containing unusual situations involving multiple occurrences of the same service on the same client are identified. For example, healthcare claims seeking payment for multiple appendectomies for a single person would be flagged because such a procedure should not logically be repeated (humans have only one appendix). Procedures that are highly unlikely to occur within a given time of a preceding service can also be flagged. For example, it is highly unlikely for a patient to be given two flu shots during the same flu season.

In a second variation, for each pair of “outcomes” occurring on an entity, the likelihood of this outcome pair co-occurring can be determined. Outcomes could be of the same nature (e.g., comparing two procedure codes that occur on a patient), or they could be of a different nature (e.g., comparing a procedure code and a diagnosis). For example, historical data might suggest that patients who are treated for herniated discs tend to have MRIs. Conversely, patients given a polio vaccine (normally performed on very young patients) are not likely to also be treated for hair loss (normally performed on older patients), and tubal ligations are not generally followed by childbirth.

Variables at any level of the hierarchy (in the case of hierarchical codes) can be compared with variables at any other level in the hierarchy. For example, if the group of codes that represent X-rays (a large set of actual procedure codes) rarely co-occurs with the group of diagnoses that represent skin conditions, entities where these outcomes co-occur will be identified for review.

There are several methods for computing which pairs of variables are least likely to co-occur. Such methods can revolve around the concept of comparing the historical co-occurrence and gauging how commonly that pair has occurred in the past, relative to how often one would expect it to occur.

One form of an equation to identify unusualness is as follows:

$$u = \frac{P ( α , β )}{\sqrt{P ( α ) P ( β )}}$$

where

u=unusualness

P=probability

α=outcome of categorical variable 1

β=outcome of categorical variable 2

In the above equation, unusualness is determined by dividing the probability of observing variables α and β together (based on historical data) by the square root of the product of the probability of observing variables α and β independently (based on historical data). Smoothing factors can be applied to ensure that there are enough observations of both α and β that the results are stable. This can be addressed by using a smoothing mechanism when computing the probabilities in the above formula.

As illustrated in Tables 1-4, various techniques can be used to look at unusualness. The basic idea always involves identifying the likelihood of a pair in the historical data, and highlighting pairs that are unlikely.

TABLE 1

| Name | Formula |
|---|---|
| Support | P(α, β) |
| Piatestsky- | P(α, β) − P(α)P(β) |
| Shapiro | |
| Interest | $\frac{P ( α , β )}{P ( α ) P ( β )}$ |
| Pointwise MI | $max \{ 0 \cdot log [ \frac{P ( α , β )}{P ( α ) P ( β )} ] \}$ |
| Cosine | $\frac{P ( α , β )}{\sqrt{P ( α ) P ( β )}}$ |
| Jaccard | $\frac{P ( α , β )}{P ( α ) + P ( β ) - P ( α , β )}$ |
| Phi-Coeff. | $\frac{P ( α , β ) - P ( α ) P ( β )}{\sqrt{P ( α ) P ( β ) P ( \overline{α} ) ) P ( \overline{β} )}}$ |

TABLE 2

| Name | Formula |
|---|---|
| Confidence | max{P(α\|β), P(β\|α)} |
| Added Value | max{P(β\|α) − P(β), P(α\|β) − P(α)} |
| klosgen | $\sqrt{P ( α , β )} max \{ P ( β \vert α ) - P ( β ) \cdot P ( α \vert β ) - P ( α ) \}$ |
| Certainty Factor | $max \{ \frac{P ( β \vert α ) - P ( β )}{1 - P ( β )} , \frac{P ( α \vert β ) - P ( α )}{1 - P ( α )} \}$ |
| Laplace | $max \{ \frac{CP ( α , β ) + 1}{CP ( α ) + 2} , \frac{CP ( α , β ) + 1}{CP ( β ) + 2} \}$ |
| Conviction | $max \{ \frac{P ( α ) P ( \overline{β} )}{P ( α , \overline{β} )} , \frac{P ( \overline{α} ) P ( β )}{P ( \overline{α} , β )} \}$ |

TABLE 3

| Name | Formula |
|---|---|
| Odds-Ratio | $o = \frac{P ( α , β ) P ( \overline{α} , \overline{β} )}{P ( α , \overline{β} ) P ( \overline{α} , β )}$ |
| Yule's O | $\frac{o - 1}{o + 1} = \frac{P ( α , β ) P ( \overline{α} , \overline{β} ) - P ( α , \overline{β} ) P ( \overline{α} , β )}{P ( α , β ) P ( \overline{α} , \overline{β} ) + P ( α , \overline{β} ) P ( \overline{α} , β )}$ |
| Yule's Y | $\frac{\sqrt{o} - 1}{\sqrt{o} + 1} = \frac{\sqrt{P ( α , β ) P ( \overline{α} , \overline{β} )} - \sqrt{P ( α , \overline{β} ) P ( \overline{α} , β )}}{\sqrt{P ( α , β ) P ( \overline{α} , \overline{β} )} + \sqrt{P ( α , \overline{β} ) P ( \overline{α} , β )}}$ |
| Kappa | $\frac{P ( α , β ) + P ( \overline{α} , \overline{β} ) - P ( α ) P ( \overline{β} ) - P ( \overline{α} ) P ( β )}{1 - P ( α ) P ( β ) - P ( \overline{α} ) P ( \overline{β} )}$ |
| Collective Strength | $[ \frac{P ( α , β ) + P ( \overline{α} , \overline{β} )}{P ( α ) P ( β ) + P ( \overline{α} ) P ( \overline{β} )} ] \times [ \frac{1 - P ( α ) P ( β ) - P ( \overline{α} ) P ( \overline{β} )}{1 - P ( α , β ) - P ( \overline{α} , \overline{β} )} ]$ |

TABLE 4

| Name | Formula |
|---|---|
| Mutual-information | $\frac{I ( α , β )}{min \{ H ( α ) , H ( β ) \}} \begin{matrix}I ( α , β ) = {\sum }_{a ε \{ α , \overline{α} \}} {\sum }_{b ε \{ β , \overline{β} \}}^{ } P ( a , b ) log \frac{P ( a , b )}{P ( a ) P ( b )} \\ H ( α ) = - {\sum }_{a ε \{ a , \overline{α} \}} P ( a ) log P ( a )\end{matrix}$ |
| J-Measure | $max \{ \begin{matrix}P ( α , β ) log \frac{P ( α \vert β )}{P ( α )} + P ( \overline{α} , β ) log \frac{P ( \overline{α} \vert β )}{P ( \overline{α} )} , \\ P ( α , β ) log \frac{P ( β \vert α )}{P ( β )} + P ( α , \overline{β} ) log \frac{P ( \overline{β} \vert α )}{P ( \overline{β} )}\end{matrix} \}$ |
| G:ni Index | $max \{ \begin{matrix}P ( α ) [ {P ( β \vert α )}^{2} + {P ( \overline{β} \vert α )}^{2} ] + \\ P ( \overline{α} ) [ {P ( β \vert \overline{α} )}^{2} + {P ( \overline{β} \vert \overline{α} )}^{2} ] - {P ( β )}^{2} - {P ( \overline{β} )}^{2} \\ P ( β ) [ {P ( α \vert β )}^{2} + {P ( \overline{α} \vert β )}^{2} ] + \\ P ( \overline{β} ) [ {P ( α \vert \overline{β} )}^{2} + {P ( \overline{α} \vert \overline{β} )}^{2} ] - {P ( α )}^{2} - {P ( \overline{α} )}^{2}\end{matrix} \}$ |
| Goodman-Kniskal | $\frac{\begin{matrix}{\sum }_{a ε \{ α , \overline{α} \}} {max}_{b ε \{ β , \overline{β} \}} P ( a , b ) + {\sum }_{b ε \{ β , \overline{β} \}}^{ } {max}_{a ε \{ α , \overline{α} \}} P ( a , b ) - \\ {max}_{a ε \{ α , \overline{α} \}} P ( a ) - {max}_{b ε \{ β , β \}} P ( b )\end{matrix}}{2 - {max}_{a ε \{ α , \overline{α} \}} P ( a ) - {max}_{b ε \{ β , \overline{β} \}} P ( b )}$ |

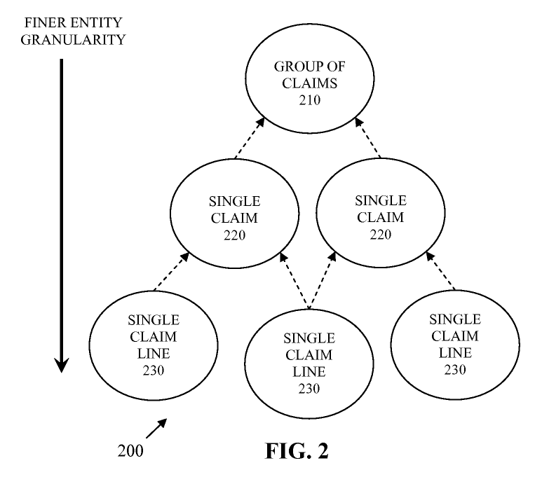

Consistency is determined at some “entity” level. FIG. 2 is a diagram 200 illustrating various entity levels which may be considered in determining whether a healthcare insurance claim is indicative of fraud or error. In this example, a coarsest granularity of an entity might comprise a group of claims 210, with finer granularities based on a single claim 220 (as a whole), or a single line in a claim 230. As one example, procedure codes and diagnosis codes (which are also referred to as variables) on a claim line can be scored for inconsistency. An entity could also include an entire healthcare insurance claim (a collection of lines), a patient, or a patient-day.

When the healthcare insurance claim is received, it can be associated with a particular entity level which is in turn used to determine the scope of the historical data for which the co-occurrence probability analysis is conducted. In some implementations, the co-occurrence analysis can be conducted at a first entity level, and if such entity level indicates fraud or error, then the analysis can be conducted a second time at a second entity level (which may require the generation of new score variables). The first entity level might include, for example, a single line of a claim while the second entity level might include all of the lines of the claim. Similarly, the first entity level might include, for example, a group of claims originating from a single healthcare facility on a particular day for a particular patient, and the second entity level might include a group of claims from that same healthcare facility and patient but over a longer time period (e.g., week, month, year, etc.).

It is critical in prepayment claim review that the results of a score are immediately actionable. Since a large number of claims are reviewed each day, a decision must be made and acted upon immediately. This type of approach is designed to be easily reviewable and immediately actionable. Notification can include a summary of information relevant to a healthcare insurance claim that is presented in an easy to understand format for a claims reviewer. The relevant outcomes for α and β can easily be displayed, and a reviewer can come to a conclusion about the claim and/or subject it to further analysis at a different entity granularity level.

Additional features of the claim are also taken into account in the score, and may be compared with historical norms. For example, if the procedure code and place of service (POS) are found to be mismatched, a reviewer may be more interested in this mismatch if the erroneous POS results in higher reimbursement. These features are incorporated into the score, and can be presented to the reviewer to make fraud more apparent.

Various implementations of the subject matter described herein may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the subject matter described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The subject matter described herein may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter described herein), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

Although a few variations have been described in detail above, other modifications are possible. For example, the logic flow depicted in the accompanying figures and described herein do not require the particular order shown, or sequential order, to achieve desirable results. In addition, it will be appreciated that the techniques used herein may be used in connection with other non-healthcare claims or data structures in which variables may be extracted in order to determine whether such claim or data structure is atypical and requires additional review or analysis. Other embodiments may be within the scope of the following claims.

What is claimed is:

1. An article comprising a tangible machine-readable medium embodying instructions that when performed by one or more machines result in operations comprising:
receiving data characterizing a healthcare insurance claim, the claim comprising variables characterizing aspects of a healthcare service for which reimbursement is sought;
generating score variables from the variables of the healthcare insurance claim;
determining whether a presence of one or more of the variables is indicative of fraud or error based on levels of co-occurrence of the one or more pairs of variables in historical healthcare insurance claims; and
initiating notification that the healthcare insurance claim is indicative of fraud based on a positive determination.

2. An article as in claim 1, wherein the pairs of variables are disjoint.

3. An article as in claim 1, wherein the notification identifies which pairs of variables are indicative of fraud or error.

4. An article as in claim 1, wherein the article embodies instructions that when performed by one or more machines result in further operations comprising:
determining a level of unusualness for historical pairs of variables.

5. An article as in claim 4, wherein the level of unusualness is determined by dividing a probability of both variables within a pair being present in the historical data by a square root of a product of a probability of a first variable within the pair being present in the historical data and a probability of a second variable within the pair being present in the historical data.

6. An article as in claim 1, wherein the article embodies instructions that when performed by one or more machines result in further operations comprising:
associating the healthcare insurance claim with an entity level; and
wherein the historical healthcare insurance claims are limited to the associated entity level.

7. A method comprising:
receiving data characterizing a healthcare insurance claim, the claim comprising variables characterizing aspects of a healthcare service for which reimbursement is sought;
generating score variables from the variables of the healthcare insurance claim;
determining whether a presence of one or more of the pairs of variables is indicative of fraud or error based on levels of co-occurrence of the one or more pairs in historical healthcare insurance claims; and
initiating notification that the healthcare insurance claim is indicative of fraud based on a positive determination.

8. A method as in claim 7, wherein the pairs of variables are disjoint.

9. A method as in claim 7, wherein the notification identifies which pairs of variables are indicative of fraud or error.

10. A method as in claim 7, further comprising:
determining a level of unusualness for historical pairs of variables.

11. A method as in claim 10, wherein the level of unusualness is determined by dividing a probability of both variables within a pair being present in the historical data by a square root of a product of a probability of a first variable within the pair being present in the historical data and a probability of a second variable within the pair being present in the historical data.

12. A method as in claim 7, further comprising:
associating the healthcare insurance claim with an entity level; and
wherein the historical healthcare insurance claims are limited to the associated entity level.

13. An article comprising a tangible machine-readable medium embodying instructions that when performed by one or more machines result in operations comprising:
receiving data characterizing a healthcare insurance claim, the claim comprising variables characterizing aspects of a healthcare service for which reimbursement is sought;
generating first score variables from the variables of the healthcare insurance claim at a first entity level;
first determining whether a presence of one or more of the first pairs of variables is indicative of fraud or error based on levels of co-occurrence of the one or more first pairs in historical healthcare insurance claims;
generating second score variables from the variables of the healthcare insurance claim at a second entity level if the first determining is positive;
second determining whether a presence of one or more of the second pairs of variables is indicative of fraud or error based on levels of co-occurrence of the one or more second pairs in historical healthcare insurance claims; and
initiating notification that the healthcare insurance claim is indicative of fraud if the second determining is positive.

14. An article as in claim 13, wherein a granularity of the first entity level is greater than a granularity of the second entity level.

15. An article as in claim 13, wherein a granularity of the second entity level is greater than a granularity of the first entity level.

16. An article as in claim 13, wherein the first pairs of variables and the second pairs of variables are disjoint.

17. An article as in claim 13, wherein the notification identifies which pairs of variables are indicative of fraud or error.

18. An article as in claim 13, wherein the article embodies instructions that when performed by one or more machines result in further operations comprising:
determining a level of unusualness for historical pairs of variables.

19. An article as in claim 18, wherein the level of unusualness is determined by dividing a probability of both variables within a pair being present in the historical data by a square root of a product of a probability of a first variable within the pair being present in the historical data and a probability of a second variable within the pair being present in the historical data.

20. An article as in claim 13, wherein the article embodies instructions that when performed by one or more machines result in further operations comprising:
associating generating of variables for the healthcare insurance claim with an associated entity level; and
wherein the historical healthcare insurance claims are limited to the corresponding associated entity level.
